(19) United States
(12) Patent Application Publication
(10) Pub. No.: US 2013/0274978 A1
(43) Pub. Date: Oct. 17, 2013

(54) CONTROL DEVICE FOR A HYBRID VEHICLE AND METHOD FOR OPERATION

(71) Applicant: ZF FRIEDRICHSHAFEN AG, Friedrichshafen (DE)

(72) Inventors: Thomas Lemp, Langenargen (DE); Stefan Gierer, Konstanz (DE)

(73) Assignee: ZF Friedrichshafen AG, Friedrichshafen (DE)

(21) Appl. No.: 13/860,067

(22) Filed: Apr. 10, 2013

(30) Foreign Application Priority Data
Apr. 16, 2012 (DE) 10 2012 206 157.6

(51) Int. Cl. B60W 20/00

(52) U.S. Cl. CPC B60W 20/40; Y10S 903/902
USPC 701/22; 903/902; 180/65.265

(57) ABSTRACT

A control device for a hybrid vehicle, comprising a hybrid drive with an internal combustion engine and an electric machine, wherein the control device, during a purely electric powered operation, compares an actual position of a crankshaft angle of the internal combustion engine with a target position for an auxiliary activation of the internal combustion engine or a target position range for an auxiliary activation of the internal combustion engine, and wherein the control device then, when said device determines that the actual position deviates from the target position by more than a limit value, determines at least one actuating variable, on the basis of which the actual position of the crankshaft angle can be altered such that, prior to the auxiliary activation of the internal combustion engine, the actual position deviates from the target position by less than the limit value, or lies within the target position range.

### PRIORITY STATEMENT

This application claims the benefit of Germany Patent Application DE 10 2012 206 157.6, filed Apr. 16, 2012, and incorporates the Germany Patent Application by reference herein in its entirety.

### FIELD OF APPLICATION

The invention relates to a control device for a hybrid vehicle according. Furthermore, the invention relates to a method for the operation of a hybrid vehicle.

### BACKGROUND

Motor vehicles are increasingly designed as hybrid vehicles, the drive assembly of which is provided as a hybrid drive, comprising an internal combustion engine and, additionally, at least one electric machine. Then, when a hybrid vehicle is operated on a purely electrical basis, the internal combustion engine of the hybrid drive is deactivated. In the case where, in a purely electrically powered operation, a torque demand cannot be provided for by the electric machine of the hybrid drive alone, the internal combustion engine must be activated in addition to the purely electrical power, or added thereto. The auxiliary activation of the internal combustion engine of a hybrid vehicle from a purely electrically powered operation could not, so far, be achieved in a reproducible manner in which the same level of quality was always ensured.

### SUMMARY

The present invention creates a novel control device for a hybrid vehicle as well as a novel method for operating a hybrid vehicle. In accordance with the invention, the control device compares an actual position of a crankshaft angle of the internal combustion engine during the purely electric powered operation with an optimal target position for an auxiliary activation of the internal combustion engine, or with an optimal target position range for the auxiliary activation of the internal combustion engine, wherein the control device then, when said control device has determined that the actual position deviates from the target position by more than a limit value, or lies outside of the target position range, determines at least one actuating variable, on the basis of which the actual position of the crankshaft angle can be altered such that, prior to the auxiliary activation of the internal combustion engine, the actual position deviates from the target position by less than the limit value, or lies within the target position range.

It is proposed with the present invention that in a purely electrically powered operation the actual position of the crankshaft angle of the deactivated internal combustion engine is monitored, and said actual position is compared with a target position, or a target position range. Depending on this comparison, the actual position of the crankshaft angle of the internal combustion engine is altered in order to subsequently ensure that the internal combustion engine is activated with a reproducibly high qualitative level. In this manner it is possible to improve the operation of a hybrid vehicle.

According to an advantageous further development, the control device generates an input signal for an electric machine of starter motor or a starter generator which engages with a crankshaft of the internal combustion engine of the hybrid drive. The altering of the actual position of the crankshaft angle toward the target position or target position range through the use of an electric machine of the starter motor or the starter generator of the internal combustion engine is particularly simple.

According to an alternative advantageous further development, the control device generates an input signal for a clutch incorporated between the internal combustion engine of the hybrid drive and the electric machine of the hybrid drive, wherein the control device generates an input value for a torque provided by the electric machine of the hybrid drive, preferably dependent on the control signal for the clutch incorporated between the internal combustion engine of the hybrid drive and the electric machine of the hybrid drive, specifically such that the torque provided by the electric machine of the hybrid drive is increased by the torque transferred to the clutch for altering the actual position of the crankshaft angle. The altering of the actual position of the crankshaft angle toward the target position or the target position range through the use of the clutch incorporated between the internal combustion engine of the hybrid drive and the electric machine of the hybrid drive can likewise be readily implemented. The torque transferred by means of the clutch in order to alter the actual position of the crankshaft angle is taken into consideration in reference to the torque provided by the electric machine of the hybrid drive by means of an input component, such that the altering of the actual position of the crankshaft angle toward the target position or target position range cannot be detected at the output drive.

The control device can execute the comparison between the actual position of the crankshaft angle and the optimal target position or target position range for the auxiliary activation of the internal combustion engine while the internal combustion engine is deactivated. The subsequent change to the actual position toward the target position or target position range then occurs based on a deactivated internal combustion engine. By this means it is possible to then execute the change to the actual position of the crankshaft angle when a combustion pressure has been reduced in the cylinders of the internal combustion engine. In this case, a particularly advantageous change to the actual position of the crankshaft angle toward the target position or the target position range is enabled.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention, including other advantages, shall be explained in greater detail below based on a few non-limiting example embodiment examples, which are depicted in the drawings. They show, schematically:

FIG. 1 is an exemplary drive train schematic for a hybrid vehicle designed as a parallel hybrid, together with a control device according to an example embodiment;

FIG. 2 is an exemplary drive train schematic for a hybrid vehicle designed as a parallel hybrid, together with a control device according to another example embodiment.

### DETAILED DESCRIPTION OF EXAMPLE EMBODIMENTS

By way of introduction, it is maintained that in the differently described example embodiments, identical parts are provided with the same reference symbols, wherein the disclosures contained in the overall description the same reference symbols or same component symbols can be applied to identical parts.

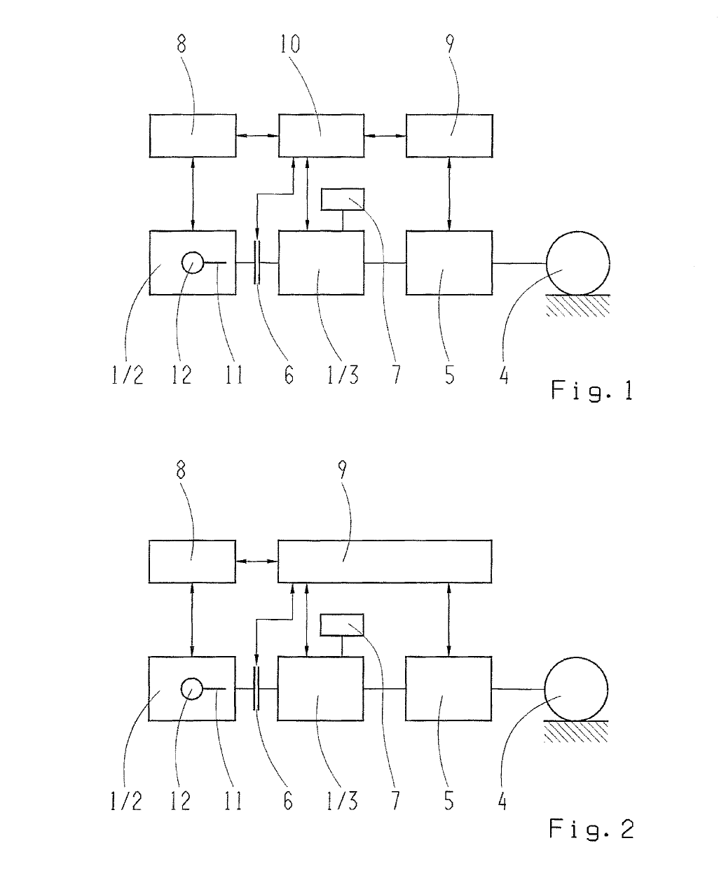

FIG. 1 shows a drive train schematic of a hybrid vehicle designed as a parallel hybrid. The hybrid vehicle according to FIG. 1 comprises a hybrid drive 1, which comprises an internal combustion engine 2 and an electric machine 3. A transmission 5 is incorporated between the hybrid drive 1 and an output drive 4 of the hybrid vehicle. A clutch 6 is incorporated between the internal combustion engine 2 of the hybrid drive 1 and the electric machine 3 of said hybrid drive.

When the clutch 6 is disengaged, the internal combustion engine 2 is decoupled from the output drive 4. When the clutch 6 is engaged, the internal combustion engine 2 is coupled to the output drive 4. An electric energy storage unit 7 acts in conjunction with the electric machine 3, which discharges more strongly when the electric machine 3 is operated as a motor, and charges more strongly when the electric machine 3 is operated as a generator.

Three control devices are shown in FIG. 1, specifically a motor control device 8, a transmission control device 9, and a hybrid control device 10. The motor control device 8 controls and/or regulates the operation of the internal combustion engine 2 of the hybrid drive 1 and exchanges data for this purpose with said engine. The transmission control device 9 controls and/or regulates the operation of the transmission 5 and exchanges data for this purpose with said transmission. The hybrid control device 10 controls and/or regulates the operation of the electric machine 3, as well as the clutch 6 incorporated between the internal combustion engine 2 and the electric machine 3, and exchanges data for this purpose with said machine and clutch. Furthermore, FIG. 1 shows both that the motor control device 8 exchanges data with the hybrid control device 10, as well as that the transmission control device 9 exchanges data with the hybrid control device 10.

FIG. 1 also shows, in a schematic form, a crankshaft 11 of the internal combustion engine 2 of the hybrid drive 1, wherein an electric machine 12 of a starter motor or a starter generator engages with the crankshaft 11.

FIG. 2 shows another drive train schematic of a hybrid vehicle designed as a parallel hybrid, whereby FIG. 2 is distinguished from FIG. 1 in that there is no separate hybrid control device present, but instead, hybrid control functions in the embodiment example in FIG. 2 are provided by the transmission control device 9.

It should be noted that the drive train schematics of a parallel hybrid shown in FIGS. 1 and 2 are of a purely exemplary nature. The invention is not limited to these drive train schematics. Moreover, the invention can be made use of with other hybrid variations, such as with a power-split hybrid.

The transmission 5 can be an automatic transmission, a continuously variable transmission, or a double clutch transmission. A clutch inside the transmission, or a start-up element external to the transmission may serve as the start-up element.

Thus, when a hybrid vehicle according to FIGS. 1 and 2 is operated purely in the electric mode, with a disengaged clutch 6, the internal combustion engine 2 of the hybrid drive 1 is decoupled from the output drive 4, and is deactivated. If a torque provided by the electric machine 3 of the hybrid drive 1 during electrically powered operation of the vehicle is insufficient for fulfilling a torque demand, then the internal combustion engine 2 may also be activated.

The present application is thus concerned with those details by means of which the auxiliary activation of the internal combustion engine 2 from a purely electric operation is possible in a particularly efficient manner.

As set forth in the context of the present application, an actual position of the crankshaft angle of the crankshaft 11 of the internal combustion engine 2 of the hybrid drive 1 is determined during a purely electric operation, and compared with an optimal target position for the auxiliary activation of the internal combustion engine 2, or an optimal target position range for the auxiliary activation of the internal combustion engine 2, respectively. This comparison is carried out, in particular, by the transmission control device 9, or alternatively, by the hybrid control device 10, wherein the motor control device 8 provides the actual position of the crankshaft angle to the hybrid control device 10 or the transmission control device 8 as an input value.

Then, when it has been determined that the actual position of the crankshaft angle deviates from the target position by more than a limit value, or that the actual position lies outside of the target position range, the actual position of the crankshaft angle is altered such that prior to the subsequent activation of the internal combustion engine 2, the actual position deviates from the target position by less than the limit value, or the actual position lies within the target position range. The transmission control device 9 generates at least one actuating variable for this, on the basis of which the change to the actual position of the crankshaft angle is executed.

Preferably this comparison of the actual position of the crankshaft angle with the target position or the target position range is executed while the internal combustion engine 2 is deactivated, such that the change to the crankshaft angle, accordingly, is carried out based on a deactivated internal combustion engine, and this being such that with the change to the crankshaft angle such that there is no combustion pressure in a combustion chamber, i.e. in cylinders, of the internal combustion engine 2. The rotation of the crankshaft 11 in order to alter the crankshaft angle first occurs then, when the combustion pressure in the combustion chamber of the internal combustion engine 2 has been reduced, such that a change to the crankshaft angle can occur with a limited torque.

According to another embodiment, the change to the actual position of the crankshaft angle occurs through the use of the electric machine 12 of the starter motor or the starter generator engaging with the crankshaft 11 of the internal combustion engine 2. For this, the internal combustion engine is then decoupled from the output drive 4, such that the rotation of the crankshaft 11, and the change to the actual position of the crankshaft angle thereby, cannot be detected at the output drive 4.

According to an alternative embodiment, the rotation of the crankshaft 11, and thereby the change to the actual position of the crankshaft angle toward the target position or target position range occurs using the clutch 6 incorporated between the internal combustion engine 2 and the electric machine 3, for which the clutch 6 is partially engaged, specifically such that a torque that can be transferred by the clutch 6 lies in the magnitude of the sum of a friction torque of the internal combustion engine 2, and a dynamic torque of the internal combustion engine 2, and a compression torque of the internal combustion engine 2 occurring with the change to the actual position. Because, by means of the partial engaging of the clutch 6, the internal combustion engine 2 is coupled to the output drive 4, the torque transferred from the clutch 6 for rotating the crankshaft 11, and thereby the change to the actual position of the crankshaft angle, must be taken into consideration in the manner of an input control for the torque provided by the electric machine 3, such that the torque provided by the electric machine 3 is increased by this input value by the torque transferred from the clutch 6, such that here as well, the change to the actual position of the crankshaft angle cannot be detected at the output drive 4.

Should there be a torque demand that cannot be provided for by the electric machine 3 of the hybrid drive 1 alone, resulting in the need to additionally activate the internal combustion engine 3, then said internal combustion engine can be jump started or activated from an actual position of the crankshaft angle, which enables an optimal and efficient activation of the internal combustion engine 2.

The target position, or the target position range, respectively, with which the actual position of the crankshaft angle is compared, is dependent on the structure of the internal combustion engine 2, and is stored in the hybrid control device 10 or in the transmission control device 9. With a four-cylinder internal combustion engine, the target position range for the crankshaft angle of the crankshaft 11 of the internal combustion engine 2 typically lies between 60° and 120° in front of the upper ignition dead-point of the target cylinder of the internal combustion engine 2.

Then, when the electric machine 12 of the starter motor or starter generator is used to rotate the crankshaft 11 or to alter the actual position of the crankshaft angle, the corresponding input signal for the electric machine 12 is provided by the hybrid control device 10 or the transmission control device 9 to the motor control device 8 as an input variable. Then, when the clutch 6 is used to alter the actual position of the crankshaft angle of the crankshaft 11, the hybrid control device 10 or the transmission control device 9 actuates the clutch 6 directly.

Although the invention is described in reference to the parallel hybrids of FIGS. 1 and 2, the invention can also be made use of with other hybrid variations such as with a power-split hybrid. Because a power-split hybrid does not exhibit the clutch 6, the change to the actual position of the crankshaft angle toward the target position or target position range occurs by means of the electric machine of the starter motor or the starter generator. For this, with a power-split hybrid, preferably an input component for the torque, provided by the electric machine of the hybrid drive, is taken into consideration, depending on the torque of the electric machine of the starter motor applied for the activation, such that the change to the actual position of the crankshaft angle cannot be detected at the output drive.

The invention enables a producible activation of a deactivated internal combustion engine of a hybrid drive from a purely electric powered operation of the hybrid vehicle. The internal combustion engine can be activated with a higher degree of quality and efficiency.

### REFERENCE SYMBOLS

1 drive system/hybrid drive

2 internal combustion engine

3 electric machine

4 output drive

5 transmission

6 clutch

7 electric energy storage unit

8 motor control device

9 transmission control device

10 hybrid control device

11 crankshaft

12 electric machine

1. A control device for a hybrid vehicle, comprising
a hybrid drive with an internal combustion engine and at least one electric machine, wherein the internal combustion engine includes a crankshaft;
wherein during a purely electric powered operation of the hybrid drive, the control device is operable to compare an actual position of a crankshaft angle of the internal combustion engine with a target position for an auxiliary activation of the internal combustion engine,
wherein when the control device has determined that the actual position deviates from the target position by more than a predetermined limit value, the control device is operable to determine at least one actuating variable that can alter the actual position of the crankshaft angle such that the actual position deviates from the target position by less than the predetermined limit value, prior to the activation of the internal combustion engine.

2. The control device according to claim 1, wherein the control device generates an input signal for an electric machine of a starter engaging with the crankshaft of the internal combustion engine of the hybrid drive for altering the actual position of the crankshaft angle.

3. The control device according to claim 1, wherein the control device generates an input signal for a clutch incorporated between the internal combustion engine of the hybrid drive and the electric machine of the hybrid drive for altering the actual position of the crankshaft angle.

4. The control device according to claim 3, wherein the control device generates the input signal for the clutch incorporated between the internal combustion engine of the hybrid drive and the electric machine of the hybrid drive such that a torque transferred by the clutch is within the sum of a friction torque of the internal combustion engine, a dynamic torque of the internal combustion engine, and a compression torque of the internal combustion engine occurring with the altering of the actual position of the crankshaft angle.

5. The control device according to claim 3, wherein the control device generates an input variable for a torque provided by the electric machine of the hybrid drive, such that the torque provided by the electric machine of the hybrid drive is increased by the torque transferred from the clutch for altering the actual position of the crankshaft angle.

6. The control device according to claim 1, wherein the control device executes the comparison between the actual position and the target position for the auxiliary activation of the internal combustion engine while the internal combustion engine is deactivated.

7. A method for the operation of a hybrid vehicle, comprising a hybrid drive with an internal combustion engine and at least one electric machine, comprising
determining and comparing an actual position of a crankshaft angle of the internal combustion engine with a target position for the auxiliary activation of the internal combustion engine during a purely electric powered operation of the hybrid drive;
altering the crankshaft angle such that the actual position deviates from the target position by less than the limit value prior to the auxiliary activation of the internal combustion engine.

8. The method according to claim 7, wherein the actual position of a crankshaft angle is altered using an electric machine of a starter engaging with a crankshaft of the internal combustion engine.

9. The method according to claim 7, wherein the actual position of a crankshaft angle is altered using a clutch incorporated between the internal combustion engine of the hybrid drive and the electric machine of the hybrid drive.

10. The method according to claim 9, wherein the clutch is partially engaged such that a torque transferred by the clutch is within the sum of a friction torque of the internal combustion engine, a dynamic torque of the internal combustion engine, and a compression torque of the internal combustion engine occurring with the altering of the actual position of the crankshaft angle.

11. The method according to claim 9, wherein an input variable for a torque provided by the electric machine of the hybrid drive is generated such that the torque provided by the electric machine of the hybrid drive is increased by the torque transferred by the clutch for altering the actual position of the crankshaft angle.

12. The method according to claim 7, wherein the comparison between the actual position and the optimal target position for the auxiliary activation of the internal combustion engine is carried out while the internal combustion engine is deactivated.

13. A control device for a hybrid vehicle, comprising
a hybrid drive with an internal combustion engine and at least one electric machine, wherein the internal combustion engine includes a crankshaft;
wherein during a purely electric powered operation of the hybrid drive, the control device is operable to compare an actual position of a crankshaft angle of the internal combustion engine with a target position range for the auxiliary activation of the internal combustion engine,
wherein when the control device has determined that the actual position lies outside of the target position range, the control device is operable to determine at least one actuating variable that can alter the actual position of the crankshaft angle such that the actual position lies within the target position range, prior to the activation of the internal combustion engine.

14. The control device according to claim 13, wherein the control device generates an input signal for an electric machine of a starter engaging with the crankshaft of the internal combustion engine of the hybrid drive for altering the actual position of the crankshaft angle.

15. The control device according to claim 13, wherein the control device generates an input signal for a clutch incorporated between the internal combustion engine of the hybrid drive and the electric machine of the hybrid drive for altering the actual position of the crankshaft angle.

16. The control device according to claim 15, wherein the control device generates the input signal for the clutch incorporated between the internal combustion engine of the hybrid drive and the electric machine of the hybrid drive such that a torque transferred by the clutch is within the sum of a friction torque of the internal combustion engine, a dynamic torque of the internal combustion engine, and a compression torque of the internal combustion engine occurring with the altering of the actual position of the crankshaft angle.

17. A method for the operation of a hybrid vehicle, comprising a hybrid drive with an internal combustion engine and at least one electric machine, comprising
determining and comparing an actual position of a crankshaft angle of the internal combustion engine with a target position range for the auxiliary activation of the internal combustion engine during a purely electric powered operation of the hybrid drive;
altering the crankshaft angle such that the actual position lies within the target position range prior to the auxiliary activation of the internal combustion engine.

18. The method according to claim 17, wherein the actual position of a crankshaft angle is altered using an electric machine of a starter engaging with a crankshaft of the internal combustion engine.

19. The method according to claim 17, wherein the actual position of a crankshaft angle is altered using a clutch incorporated between the internal combustion engine of the hybrid drive and the electric machine of the hybrid drive.

20. The method according to claim 19, wherein the clutch is partially engaged such that a torque transferred by the clutch is within the sum of a friction torque of the internal combustion engine, a dynamic torque of the internal combustion engine, and a compression torque of the internal combustion engine occurring with the altering of the actual position of the crankshaft angle.
